(19) United States
(12) Patent Application Publication
(10) Pub. No.: US 2014/0042987 A1
(43) Pub. Date: Feb. 13, 2014

(54) LIGHTNING ENERGY STORAGE SYSTEM

(71) Applicant: JAMES CHYI LAI, Saint Paul, MN (US)

(72) Inventor: JAMES CHYI LAI, Saint Paul, MN (US)

(73) Assignee: NORTHERN LIGHTS SEMICONDUCTOR CORP., SAINT PAUL, MN (US)

(21) Appl. No.: 13/571,057

(22) Filed: Aug. 9, 2012

(51) Int. Cl. H02J 7/00

(52) U.S. Cl. 320/166

(57) ABSTRACT

Embodiments of the present invention relate to an apparatus and method for collecting and/or storing electrical energy in lightning. A specific embodiment provides a lightning energy storage system that includes a lightning rod, a wire, a lightning energy harvester, and a ground rod. The lightning rod is configured to attract lightning and transfer electrical energy. The lightning energy harvester incorporates at least one magnetic capacitor and a switch. The ground rod is connected to the wire. A control signal controls the switch to direct the electrical energy to ground through the ground rod or to direct the electrical energy to charge the magnetic capacitor, in response to a charging state of the magnetic capacitor.

### TECHNICAL FIELD

Embodiments of the present invention relate to an energy storage system. Specific embodiments pertain to a lightning energy storage system.

### BACKGROUND OF INVENTION

For years people have been attempting to find an effective and inexpensive energy source for various energy consuming facilities of modern day living, commerce, and technology. One of the prime concerns in utilizing the energy sources is how to achieve environmentally protective eco-friendly resources.

Lightning is a phenomenon of an atmospheric electrical discharge. When the electric field becomes strong enough, an electrical discharge (the bolt of lightning) occurs within clouds or between clouds and the ground. Lightning occurs with both positive and negative polarity. An average bolt of negative lightning carries an electric current of 30,000 amperes (30 kA), and transfers 15 coulombs of electric charge and 500 megajoules of energy. Large bolts of lightning can carry up to 120 kA and 350 coulombs. An average bolt of positive lightning carries an electric current of about 300 kA—about 10 times that of negative lightning.

Therefore, it would be beneficial to have an apparatus to collect and/or store the electrical energy of lightning.

### BRIEF SUMMARY

Embodiments of the invention relate to an apparatus and method for collecting and/or storing the electrical energy. Specific embodiments are directed to an apparatus and method for collecting and/or storing the electrical energy of lightning. A specific embodiment pertains to a lightning energy storage system that includes a lightning rod, a wire, a lightning energy harvesting unit and a ground rod. The lightning rod is configured to attract lightning and transfer electrical energy. The lightning energy harvesting unit incorporates at least one magnetic capacitor and a switch. The magnetic capacitor comprises a first magnetic section, a second magnetic section, and a dielectric section configured between the first magnetic section and the second magnetic section. The dielectric section is configured to store the electrical energy and has a thickness of at least 10 angstrom to reduce, and preferably prevent, electrical energy leakage. The ground rod is connected to the wire. A control signal controls the switch to direct the electrical energy to ground through the ground rod or to direct the electrical energy to charge the magnetic capacitor in response to a charging state of the magnetic capacitor.

In an embodiment, the thickness of the dielectric section is 100 angstrom.

In an embodiment, the lightning energy harvesting unit further comprises a transformer connected to the wire to adjust a voltage of the electrical energy to charge the magnetic capacitor.

In an embodiment, the lightning energy harvesting unit is packaged in a box, wherein the box has an environmentally sealing cover.

In an embodiment, the lightning energy harvesting unit further comprises a detector to detect the charging state of the magnetic capacitor and issue the control signal is response to the charging state.

In an embodiment, the lightning energy harvesting unit comprises a plurality of magnetic capacitors that are parallel connection and fabricated in a substrate.

In an embodiment, the substrate further comprises a first connector and a second connector, the electrical energy charges the magnetic capacitors through the first connector and the magnetic capacitors supply the electrical energy to an external device through the second connector.

In an embodiment, the substrate further comprises a third connector connected to the ground rod.

In an embodiment, when the charging state of the magnetic capacitors are fully charged, the switch switches the first connector to connect with the third connector to direct the electrical energy to the ground rod, and when the charging state of the magnetic capacitors are not fully charged, the switch switches the first connector to connect with the magnetic capacitors to direct the electrical energy to charge the magnetic capacitors.

### BRIEF DESCRIPTION OF DRAWINGS

In order to make the foregoing as well as other aspects, features, advantages, and embodiments of the present disclosure more apparent, the accompanying drawings are described as follows:

FIG. 1 is a schematic block diagram of an apparatus for collecting and storing the electrical energy in lightning in accordance with an embodiment of the disclosure.

FIG. 2 is a schematic diagram of a magnetic capacitor to store electrical energy in lightning according to an embodiment of the disclosure.

FIG. 3 is a schematic diagram of a plurality of magnetic capacitors fabricated in a substrate together to store electrical energy in lightning according to an embodiment of the disclosure.

FIG. 4 is a schematic diagram of a plurality of magnetic capacitor fabricated in a substrate together to store electrical energy in lightning according to another embodiment of the disclosure.

FIG. 5 is a schematic block diagram of an apparatus for collecting and storing the electrical energy in lightning in accordance with another embodiment of the disclosure.

### DETAILED DISCLOSURE

Reference will now be made in detail to the various embodiments of the disclosure, one or more examples of which are illustrated in the figures. Each example is provided by way of explanation of the disclosure, and is not meant as a limitation of the disclosure. For example, features illustrated or described as part of one embodiment can be used in conjunction with other embodiments to yield yet a further embodiment. It is intended that the present disclosure includes such modifications and variations.

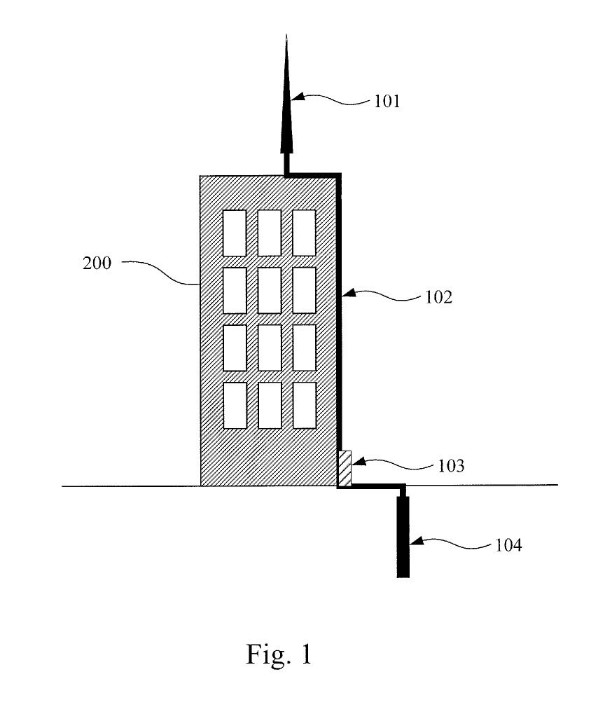

FIG. 1 is a schematic block diagram of an apparatus for collecting and storing the electrical energy in lightning. The apparatus 100 for collecting and storing the electrical energy in lightning includes one or more lightning rod 101, a wire 102, one or more lightning energy harvester (LEH) units 103 and a ground rod 104. The lightning rod 101 is structured to attract lightning and transfer electrical energy. The lightning rod 101 is a metal rod or metallic object mounted on top of a building 200. In another embodiment, the lightning rod 101 is mounted on top of a tower 201.

The wire 102 is disposed in connecting between the lightning rod 101 and the lightning energy harvester (LEH) unit 103 or ground rod 104. The structural adaptation of the wire 102 is such as to direct electrical energy from the lightning rod 101 to the lightning energy harvester (LEH) unit 103 for storing or the ground rod 104 for discharging.

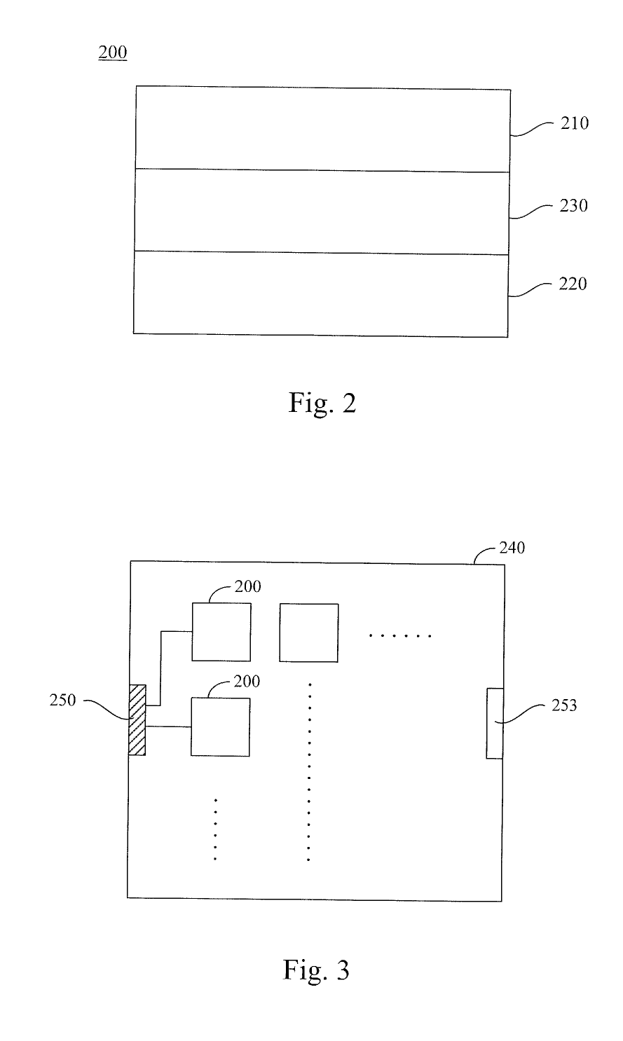

In an embodiment, the lightning energy harvester unit 103 is packaged in a box. The box has environmentally sealed cover for safety and protection from weather elements. The lightning energy harvester (LEH) unit 103 is composed of one or more magnetic capacitor 200. Magnetic capacitor is constructed based on the GMC (Giant Magnetic Capacitance) theory. It has a capacitance 10⁶-10¹⁷ times larger than that of standard capacitor of equivalent dimensions and dielectric materials. A magnetic capacitor is an energy storage apparatus. FIG. 2 shows a schematic diagram of a magnetic capacitor to store electrical energy in lightning according to an embodiment of the disclosure. An magnetic capacitor 200 has a first magnetic section 210, a second magnetic section 220, and a dielectric section 230 configured between the first magnetic section 210 and the second magnetic section 220. The dielectric section 230 is a thin film, and the dielectric section 230 is composed of dielectric material, such as BaTiO₃ or TiO₃. The dielectric section 230 is arranged to store electrical energy, and the first magnetic section 210 and the second magnetic section 220 are needed to generate the insulating-effect to prevent the current from passing through (i.e. electrical energy, leakage). The dielectric section 230 further has a thickness at least 10 angstroms (Å) to prevent the electrical energy leakage. In an embodiment, the thickness of the dielectric section 230 is at least 10 Å, at least 100 Å, and/or 100 Å to prevent the electrical energy leakage.

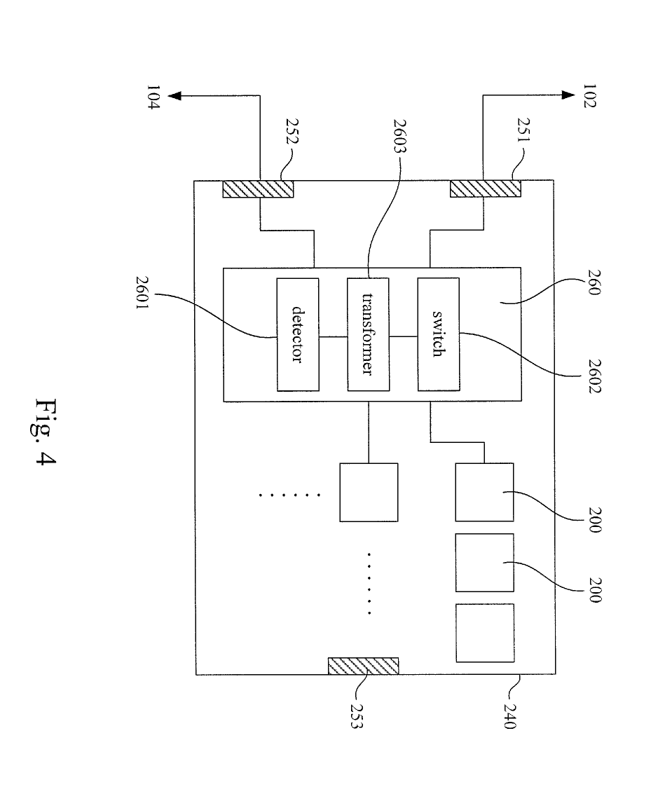

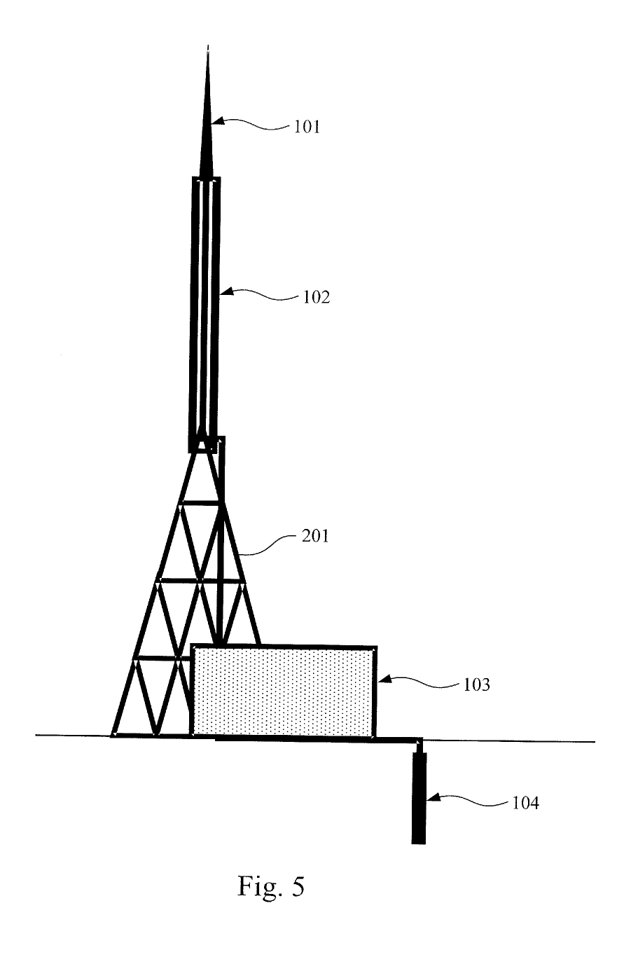

In another embodiment, a plurality of magnetic capacitors 200 may be fabricated in a substrate 240 together to form the lightning energy harvester unit 103 as illustrated in FIG. 3. A connector 250 is formed in the substrate 240 for connecting to wire 102. These magnetic capacitors 200 are connected in parallel and connected to the connector 250 to receive the electrical energy in lightning and to the connector 253 for supplying electrical energy to an external device.

In another embodiment, the lightning energy harvester unit 103 further comprises a power management module 260. The power management module 260 connects to the wire 102 through a connector 251 and connects to the ground rod 104 through the connector 252. The power management module 260 includes a detector 2601 and a switch 2602. The detector 2601 detects the magnetic capacitor 200 to determine an electrical energy state stored in the magnetic capacitors 200. In an embodiment, when the electrical energy stored in the magnetic capacitors 200 is over a set value, the detector 2601 issues a control signal to the switch 2602 to switch the switch 2602 to direct the electrical energy in lightning to ground through the ground rod 104. For example, the lightning rod 101 receives the electrical energy in lightning to charge these magnetic capacitors 200. The detector 2601 detects the charging state of theses magnetic capacitor 200 in real time. When the detector 2601 determines these magnetic capacitors 200 are fully charged, the detector 2601 issues a control signal to switch the switch 2602 to direct the electrical energy in lightning to ground through the ground rod 104. Moreover, in a specific embodiment, the power management module 260 further includes a transformer 2603 to transform the voltage of the electrical energy in lightning to a charging voltage to charge these magnetic capacitors 200.

It will be apparent to those ordinarily skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A lightning energy storage system, comprising:
a lightning rod configured to attract lightning and transfer electrical energy;
a wire;
a lightning energy harvesting unit, wherein the lightning energy harvesting unit comprises at least one magnetic capacitor and a switch, wherein each of the at least one magnetic capacitor comprises:
a first magnetic section;
a second magnetic section; and
a dielectric section configured between the first magnetic section and the second magnetic section, wherein the dielectric section is structured to store the electrical energy, wherein the dielectric section has a thickness of at least 10 angstroms; and
a ground rod,
wherein a control signal controls the switch to direct the electrical energy to ground through the ground rod or to direct the electrical energy to charge the at least one magnetic capacitor in response to a charging state of the at least one magnetic capacitor.

2. The system of claim 1, wherein the thickness of the dielectric section is at least 100 angstroms.

3. The system of claim 1, wherein the lightning energy harvesting unit further comprises a transformer connected to the wire, wherein the transformer adjusts a voltage of the electrical energy to charge the at least one magnetic capacitor.

4. The system of claim 1, wherein the lightning energy harvesting unit is packaged in a box, wherein the box has an environmentally sealing cover.

5. The system of claim 1, wherein the lightning energy harvesting unit further comprises a detector to detect the charging state of the at least one magnetic capacitor and issue the control signal in response to the charging state.

6. The system of claim 1, wherein the at least one magnetic capacitor comprises a plurality of magnetic capacitors, wherein the plurality of magnetic capacitors are connected in parallel.

7. The system of claim 2, wherein the thickness of the dielectric section is 100 angstroms.

8. The system of claim 7, wherein the substrate further comprises a first connector and a second connector, wherein the electrical energy charges the plurality of magnetic capacitors through the first connector and the plurality of magnetic capacitors supply the electrical energy to an external device through the second connector.

9. The system of claim 8, wherein the substrate further comprises a third connector connected to the ground rod.

10. The system of claim 9, wherein when the charging state of the plurality of magnetic capacitors is fully charged, the switch switches the first connector to connect with the third connector to direct the electrical energy to the ground rod.

11. The system of claim 9, wherein when the charging state of the plurality of magnetic capacitors is not fully charged, the switch switches the first connector to connect with the plurality of magnetic capacitors to direct the electrical energy to charge the plurality of magnetic capacitors.

12. The system of claim 2, wherein the thickness of the dielectric section is 100 angstroms.
